(19) United States
(12) Patent Application Publication
(10) Pub. No.: US 2014/0230541 A1
(43) Pub. Date: Aug. 21, 2014

(54) FLOW METER COMPRISING A MEASURING INSERT WHICH IS INSERTABLE INTO A CASING

(71) Applicant: Landis+Gyr GmbH, Nurnberg (DE)

(72) Inventors: Peter HEROLD, Nurnberg (DE); Thomas GÖLZHÄUSER, Nurnberg (DE); Thomas ADLER, Nurnberg (DE); Stefan FISCHER, Schwabach (DE)

(73) Assignee: Landis+Gyr GmbH, Nurnberg (DE)

(21) Appl. No.: 14/185,258

(22) Filed: Feb. 20, 2014

(30) Foreign Application Priority Data
Feb. 21, 2013 (DE) 10 2013 202 852.0

(51) Int. Cl. G01F 15/14

(52) U.S. Cl. CPC G01F 15/14
USPC 73/273

(57) ABSTRACT

The flow meter for one of a liquid and a gaseous medium comprises a casing and a measuring insert which is insertable into said casing. The measuring insert as a structural unit includes at least one first sound transducer for emitting a first sound signal into a measuring path through which the medium flows during operation and a second sound transducer for receiving the first sound signal after passing through the measuring path, and the measuring path through which the medium flows during operation when the measuring insert is inserted. The measuring path has an actual measuring channel comprising a measuring channel inlet opening for the medium, a measuring channel outlet opening for the medium and at least one measuring channel wall, wherein the measuring channel wall at least partly surrounds the measuring path in the direction of flow, and the casing has a casing wall, and a constriction is provided in an intermediate region between the measuring channel wall and the casing wall. In the region of the constriction, a remaining opening is provided between the measuring channel wall and the casing wall.

### CROSS-REFERENCES TO RELATED APPLICATIONS

This application claims the priority of German Patent Application, Serial No. 10 2013 202 852.0, filed Feb. 21, 2013, pursuant to 35 U.S.C. 119(a)-(d), the content of which is incorporated herein by reference in its entirety as if fully set forth herein.

### FIELD OF THE INVENTION

The invention relates to a flow meter for one of a liquid and a gaseous medium.

### BACKGROUND OF THE INVENTION

Flow meters of this type based on (ultra)sonic measurement technology are known. Pulse-shaped (ultra)sound signals are generated by means of an (ultra)sound transducer and emitted through the medium in the direction of flow and opposite to the direction of flow. The running time difference between the sound signals in both directions of flow is evaluated to determine the flow rate of the medium. The operating principle of ultrasound-based flow meters is based on said running time difference.

There are various designs. On the one hand, devices are known which are configured as flow meters in the proper sense of the word, in other words they are used to determine only the flow rate of the medium. On the other hand, there are energy meters, for instance in the form of heat or cold meters, in which the flow rate determined according to the principle explained above is related to the temperature difference between the inflow and the outflow detected by means of a pair of thermocouples so as to determine the (heat or cold) energy supplied via the medium. In this disclosure, energy meters of this type are to be understood as—specially designed—flow meters as well.

The sound signal can be emitted through the medium to be detected along different transmission paths. It is advantageous if the entire flow profile of the medium is detected. In order to achieve this, EP 1 337 810 B1 describes a flow meter in which a helical transmission path is provided for the sound signal when propagating through the medium to be detected. The helical transmission path through the medium is obtained in such a way that the sound signal emitted by the sound transducer is reflected by the walls of the measuring tube surrounding the measuring path.

Other embodiments of ultrasonic flow meters comprising a replaceable measuring insert are known. For instance, EP 0 890 826 B1 describes a replaceable trough-shaped measuring insert made of plastic comprising reflection discs arranged in special pockets. Furthermore, EP 0 477 418 A1 describes a flow meter comprising a measuring insert in the form of a trough-like sheet metal structure. The ultrasonic flow meter disclosed in EP 2 006 646 A1 is provided with a replaceable measuring insert as well in which the sound transducers are arranged on opposite sides of the measuring path. The replaceability of the measuring inserts facilitates maintenance and, if necessary, new (certified) calibration.

Although many ultrasonic flow meters are already known, there is still a need for improved solutions in terms of handling, operational safety and/or measuring accuracy of such devices.

### SUMMARY OF THE INVENTION

An object of the invention is to provide a flow meter of the type named at the outset which is further improved compared to conventional flow meters.

This object is achieved by a flow meter for one of a liquid and a gaseous medium, the flow meter comprising a casing and a measuring insert which is insertable into said casing, wherein the measuring insert, in the form of an in particular multi-component structural unit, includes in particular at least one first sound transducer, in particular a first ultrasound transducer, for emitting a first sound signal into a measuring path through which the medium flows during operation, and a second sound transducer, in particular a second ultrasound transducer, for receiving the first sound signal after passing through the measuring path through which the medium flows during operation and which includes the measuring path through which the medium flows during operation when the measuring insert is installed, wherein the measuring path has an actual measuring channel comprising a measuring channel inlet opening for the medium, a measuring channel outlet opening for the medium and at least one measuring channel wall, wherein the measuring channel wall at least partly surrounds the measuring path in the direction of flow and the casing has a casing wall and a constriction is provided in an intermediate region between the measuring channel wall and the casing wall when the measuring insert is installed, wherein a remaining opening is provided between the measuring channel wall and the casing wall in the region of the constriction.

It was found that the constriction helps to ensure that the medium primarily flows through the measuring path so that only a slight amount of the medium, which is irrelevant for flow measurement, is guided past the measuring path in the form of a passive flow that is not detectable. This increases the measuring accuracy of the flow meter. The constriction is preferably formed between an outside of the measuring channel wall and an inside of the casing wall.

Favourably, a remaining opening is provided between the measuring channel wall and the casing wall in the region of the constriction. The remaining opening ensures that the constriction is on the one hand narrow enough to ensure that only a slight amount of the flow is guided past the measuring path in the form of a passive flow that is irrelevant for flow measurement. On the other hand, the remaining opening preferably prevents the form ation of a dead zone where medium flow comes to a stop in front of the constriction. In the medium that has come to a stop in front of the constriction, bacteria might develop which might cause problems in particular if the flow meter is installed in a drinking water line.

The measuring channel wall is in particular connected to an end plate in such a way that a bond is formed, for instance by welding or soldering. Naturally, there are also other ways of connecting the measuring channel wall to the end plate. In particular a mechanically stable connection is provided between these two components of the measuring insert.

The sound transducers may be configured in various ways. Each of the sound transducers may in particular be configured as a sound emitter or a sound receiver. This allows sound signals, which are for instance pulse-shaped, to be emitted into the measuring path both in the direction of flow of the medium and opposite to the direction of flow thereof, allowing the flow rate of the medium to be determined according to the principles of running time difference. In other words, a second sound signal is generated together with the first sound signal which second sound signal propagates along the measuring path in a direction that is opposite to that of the first sound signal.

Preferably, all components of the measuring insert, apart from the sound transducers and the seals the device may be provided with, are made of the same material. This allows the various materials to be joined together more easily, thus resulting in a simplified production process and an improved operational behaviour. Another advantage is that temperature-related mechanical stresses between the individual components, which may occur when the measuring insert is made of different materials, are prevented.

According to a favourable embodiment, the constriction is formed by an in particular web-shaped protrusion on at least one of the measuring channel wall or the casing wall. A protrusion forming the constriction may also be provided on each of the two walls. A protrusion of this type is easy to produce while providing a very effective way of constricting or sealing the intermediate region between the casing wall and the measuring channel wall. Preferably, the constriction may be produced without requiring any other component, in particular without requiring an additional seal.

According to another favourable embodiment, the constriction runs around in particular the entire outside of the measuring channel wall. Therefore, there is no increase of the opening cross-section anywhere in the pipe which might allow an excess portion of the medium to enter the intermediate region between the housing wall and the measuring channel wall, causing a passive flow to develop that is no longer irrelevant for flow measurement.

According to another favourable embodiment, the measuring insert ineludes at least one end plate which seals a casing opening of the casing into which the measuring insert is insertable in such a way as to prevent an escape of the medium, and which is provided with at least one of the two sound transducers, and at least one outer transducer cover which covers, in particular seals, at least one of the two sound transducers on an outside of the end plate remote from the medium. The additional outer cover of the sound transducers allows the operational safety of the flow meter to be further improved. The transducer cover provided on the outside of the end plate remote from the medium protects the key components of the (ultra)sonic flow meter, with the result that the total error rate of the device is reduced considerably. The relevant transducer cover may be configured in various ways. On the one hand, it is conceivable for the transducer cover to be configured as a cover plate. Alternatively, it is conceivable to provide an in particular multi-component cover structure comprising a cover hood which in particular seals at least one of the sound transducers and an additional cover plate. Other embodiments are conceivable as well.

In a favourable embodiment, the transducer cover is rigidly secured to the end plate and is in particular removable only by means of tools. In other words, the transducer cover is in particular configured to prevent mechanical access to the at least one sound transducer when the measuring insert is installed in the casing. As a result, manipulations of the sound transducer are prevented or are at least virtually impossible.

According to another favourable embodiment, a seal is arranged between the transducer cover and the end plate. The transducer cover sealed in this manner is in particular configured to protect the at least one covered sound transducer from exposure to external influences such as moisture and/or radiation, in particular electromagnetic radiation so as to improve the EMC, during operation.

According to another favourable embodiment, an electric connection wire is guided through the transducer cover to at least one of the two sound transducers in a sealed manner, for instance by means of a sealed cable gland. This also helps to protect the covered sound transducer from exposure to external influences during operation.

According to another favourable embodiment, a common transducer cover is provided for the first sound transducer and for the second sound transducer. This is in particular advantageous if the sound transducers are arranged on the same side of the measuring path and in close proximity to each other. In this case, it is advantageous to use only one transducer cover for both sound transducers.

According to an alternative embodiment, it is conceivable as well to provide a separate transducer cover for each of the first and second sound transducers. This is in particular advantageous if the sound transducers are arranged on different sides of the measuring path or very far apart from each other. In this case, it is advantageous to use an individual transducer cover for each sound transducer.

According to another favourable embodiment, the measuring insert is replaceably insertable into the casing. In this case, the measuring insert is removable very easily, for instance in order to perform maintenance and/or a new (certified) calibration. Meanwhile, the opening in the casing in which the measuring insert is usually arranged can be closed by means of a simple lid. Alternatively, it is conceivable to install another measuring insert of a similar design. In any case, the pipe through which the medium flows in particular needs to be shut off only during the short time required for replacing the measuring insert. As a result, the laborious and time-consuming process of demounting and remounting fittings configured as pipe components is no longer necessary. This favourable replaceability is in particular due to the fact that the measuring insert preferably comprises all components required for the operation of the flow meter.

According to another favourable embodiment, the casing is configured either as a separate component, for instance a separate fitting casing, to be installed in a pipe through which the medium flows or as an integral part of a pipe through which the medium flows. A casing configured as a separate component offers advantages in terms of a defined installation geometry while a casing configured as an integral pipe component requires less space.

According to another favourable embodiment, the measuring path has an actual measuring channel comprising a measuring channel wall, with at least the measuring channel wall being made of or including a metal. As a result, a structure is obtained which is extremely resistant to aging and wear. Furthermore, a measuring channel wall made of a metal allows additional components to be dispensed with which would otherwise be required in order to provide reflection points. So in this case, reflection of the sound signal(s) may then occur directly on the measuring channel wall.

Further features, advantages and details of the invention will be apparent from the following description of embodiments, given with reference to the drawing.

### BRIEF DESCRIPTION OF THE DRAWING

FIG. 1 shows a longitudinal sectional view, seen from the side, of a first exemplary embodiment of a flow meter comprising a measuring insert which is replaceably insertable into a casing and comprises sealed ultrasound transducers;

FIG. 2 shows an enlarged longitudinal sectional view of the measuring insert of the flow meter according to FIG. 1 comprising a cover plate for covering the outside of the ultrasound transducers;

FIG. 3 shows a front view of a measuring channel inlet opening of the measuring insert of the flow meter according to FIG. 1; and

FIG. 4 shows a second exemplary embodiment of a flow meter comprising a measuring insert which is replaceably insertable into a casing, the Figure showing a top view of a longitudinal section through a constriction between a measuring channel wall and a casing wall.

### DESCRIPTION OF THE PREFERRED EMBODIMENTS

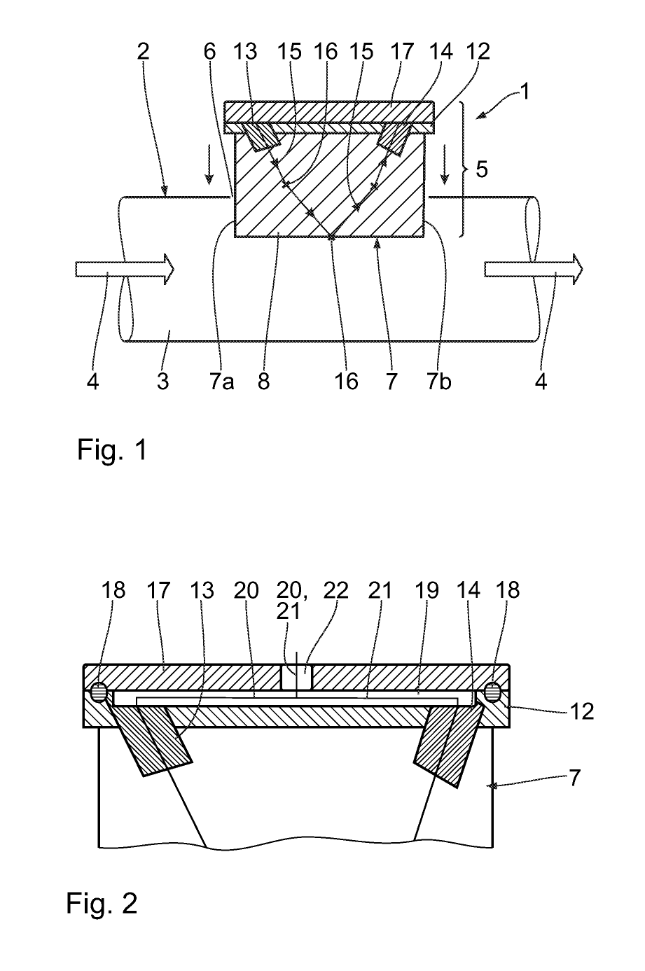

Mutually corresponding parts are designated by the same reference numerals throughout FIGS. 1 to 4. Details of the exemplary embodiments described in more detail below may form an invention per se or part of a subject matter of an invention.

FIGS. 1 to 3 show an exemplary embodiment of a flow meter 1 for detecting the flow rate of a medium 3 flowing through a casing 2. The medium 3 flows through the casing 2 in the direction of flow 4 indicated by the arrows. In the described embodiment, the casing 2 is a pipe section of a pipe system through which the medium 3 to be detected flows. An alternative design in the form of a separate fitting casing that is installed separately into the pipe system is conceivable as well (see also the following exemplary embodiment according to FIG. 4 described below).

The flow meter 1 is ultrasound-based and works according to the principles of running time difference. The exemplary embodiment shown in FIGS. 1 to 3 is configured to detect the flow rate of the medium 3. This is however not meant to be limiting. The flow meter 1 may also form a component of a combined detection unit, for instance for detection of an amount of heat or cold energy supplied via the pipe system. To this end, additional temperature sensors, which are not shown in FIG. 1, are provided to detect a temperature difference between inflow and outflow. A heat or cold meter configured in this manner then detects the heat or cold energy which is supplied via the pipe system and is then used. The following description only concerns the detection of the flow rate of the medium 3 without limiting the generality of the foregoing.

The flow meter 1 comprises a replaceable measuring insert 5 which is insertable into an opening 6 of the casing 2. FIG. 1 shows a state in which the measuring insert 5 is only partially inserted into the opening 6 and is therefore not in its final mounting position.

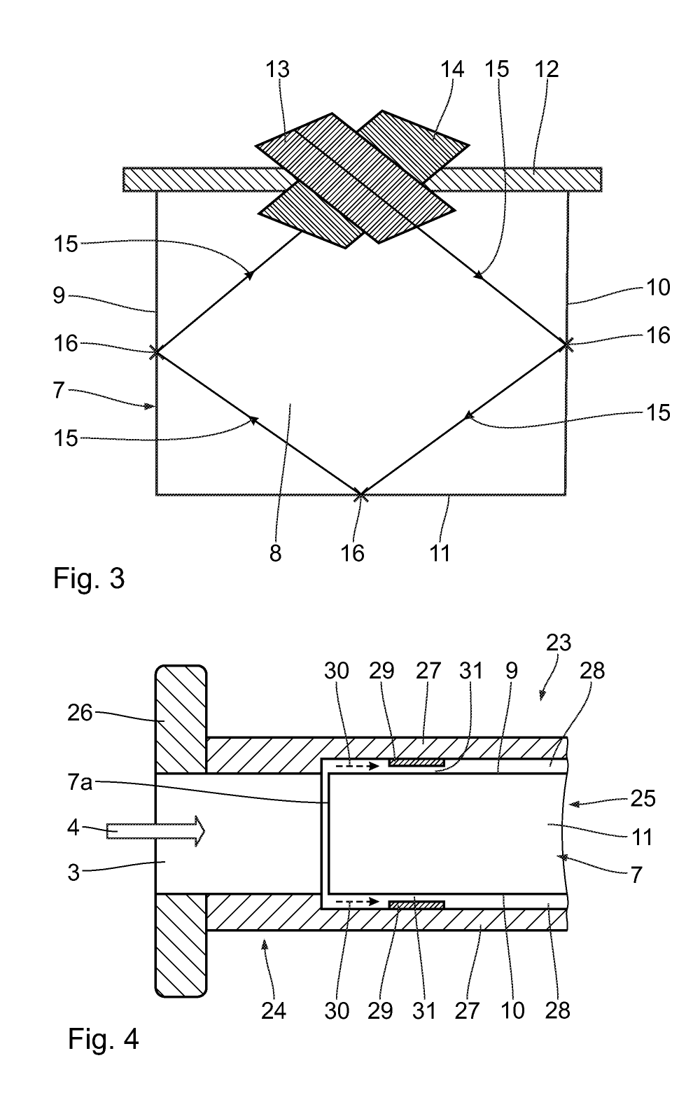

The measuring insert 5 comprises a measuring channel 7 which surrounds the actual measuring path 8 in the form of a bent metal sheet. The front view according to FIG. 3 shows that the measuring channel 7 has two measuring channel side walls 9 and 10 and a measuring channel bottom wall 11. The measuring channel 7 further has a measuring channel inlet opening 7a on the inlet side and a measuring channel outlet opening 7b on the outlet side (see FIG. 1).

The casing 2 may also be provided with mechanical or other means to ensure a correct mounting position of the measuring insert 5 when installed in the casing 2. Relative to the direction of flow 4 of the medium 3, the measuring insert 5 is always installed in the correct orientation, allowing the medium 3 to enter the measuring path 8 via the measuring channel inlet opening 7a and to be discharged from the measuring path 8 via the measuring channel outlet opening 7b. In an alternative exemplary embodiment not shown, the measuring insert 5 may also be rotatable, in other words there is no preferred orientation 1 for the measuring insert 5 to be installed relative to the direction of flow 4. In this alternative embodiment, the measuring insert 5 is extremely variable and in particular insertable in both directions of flow.

The measuring channel side walls 9 and 10 are connected to an end plate 12 in such a way that a bond is formed between them. The end plate 12 is also made of a metal. In the illustrated exemplary embodiment, it is joined to the measuring channel side walls 9 and 10 by welding. This connection offers mechanical stability. The end plate 12 is placed on the edge of the opening 6 of the casing 2 in a sealed manner.

The end plate 12 is provided with two ultrasound transducers 13 and 14. In the illustrated exemplary embodiment, the ultrasound transducers 13 and 14 are screwed into the end plate 12 so that a seal is provided at the same time as well which prevents the medium 3 from passing through the screw connection. The ultrasound transducers 13 and 14 are oriented in such a way that a sound signal 15 which is generated or received by them is emitted or received at an oblique angle relative to the direction of flow 4 (see the path of the sound signal shown in FIG. 1). Furthermore, the ultrasound transducers 13 and 14 have an oblique orientation relative to the orientation of the side walls 9 and 10. Their emitting and receiving radiation patterns are in each case directed towards one of the two measuring channel side walls 9 and 10 (see path of the sound signal 15 shown in FIG. 3). As a result, the sound signal 15 follows a helical path when propagating along the measuring path 8 and has a number of reflection points 16 on the measuring channel side walls 9 and 10 and on the measuring channel bottom wall 11. Due to the fact that the measuring channel side/bottom walls 9, 10, 11 are made of metal anyway so that their surfaces—which are polished if necessary—show very good reflection properties for the sound signal 15, no particular measures are necessary for providing the reflection points 16.

The ultrasound transducers 13, 14 are in each case configured to emit and to receive the sound signal 15. As a result, there are two directions of sound propagation one of which substantially corresponds to the direction of flow 4 while the other substantially corresponds to the direction opposite to the direction of flow 4. The running time difference between these two opposite sound signals 15 is then used to determine, by means of an evaluation unit not shown in more detail, the flow rate of the medium 3. When the measuring insert 5 is mounted, the end plate 12 in which the ultrasound transducers 13, 14 are installed seals the entire opening 6 of the casing 2. The connection is rigid but detachable and is for example a screw connection. In addition, a seal is provided which is not shown in more detail and prevents an escape of the medium 3.

On the outside of the end plate 12 remote from the medium 3, a cover plate 17 is provided which is also detachably mounted to the end plate 12. In the connection area between the two plates 12 and 17, another seal 18 is arranged which seals an inner region 19 formed between the two plates 12 and 17 from exposure to external influences such as moisture. Therefore, the cover plate 17 ensures that the ultrasound transducers 13, 14 are securely covered. Furthermore, it protects the two transducers 13 and 14 from exposure to other external influences such as electromagnetic radiation, thus improving the EMC behaviour of the flow meter 1. Moreover, the cover plate 17 prevents mechanical access to the ultrasound transducers 13 and 14, which makes it impossible or at least virtually impossible to undesirably damage or manipulate the sound transducer. An access to the ultrasound transducers 13, 14 is only possible by removing the cover plate 17 which, however, in particular requires the use of tools.

The electric connection ends of the ultrasound transducers 13 and 14 protrude into the protected inner region 19. Electric connection wires 20 and 21 of the ultrasound transducers 13 and 14 are guided through the cover plate 17 by means of a sealed lead-through 22 which is configured as a cable gland in the illustrated exemplary embodiment (see FIG. 2).

Consequently, the flow meter 1 has a very advantageous replaceable measuring insert 5 which has a multi-component structure and the components of which include the measuring channel 7, the end plate 12, the ultrasound transducers 13 and 14 inserted therein, the cover plate 17 and various seals. The measuring insert 5 forms a structural unit and is therefore entirely removable from the casing 1, for instance for maintenance or (certified) calibration. The measuring insert 5 comprises all components which are relevant for measurement, in particular allowing a (certified) calibration to be performed outside the casing 2 and, what is more, at a facility established for this purpose. In the meantime, the casing 2 may remain on site. Once the opening 6 has been provided with a temporary seal such as a lid, the pipe system in which the flow meter 1 is installed may advantageously remain in operation while the works are being carried out on the removed measuring insert 5.

Another advantage is the rugged design of the measuring insert 5. The cover plate 17 protects the ultrasound transducers 13 and 14 from exposure to external influences and from potential manipulations.

Consequently, the flow meter 1 offers advantages during operation and during maintenance and (certified) calibration primarily because of the measuring insert 5.

FIG. 4 shows another embodiment of a flow meter 23. The flow meter 23 comprises a separate fitting casing 24 which is in turn provided with a replaceable measuring insert 25. Shown in a schematic view in FIG. 4, the measuring insert 25 is substantially configured like the measuring insert 5 of the flow meter according to FIGS. 1 to 3. Therefore, reference shall be made to the corresponding description of the measuring insert 5. The measuring insert 25 has a measuring channel 7 as well, comprising a measuring channel inlet opening 7a on the inlet side, a measuring channel outlet opening 7b on the outlet side and measuring channel side/bottom walls 9, 10, 11.

As already explained above, the fitting casing 24 is configured to be separately installed in a pipe system. To this end, the two connection points are provided with flange elements 26. The fitting casing 24 further has a casing wall 27. When the measuring insert 25 is installed, a narrow intermediate region 28 is formed between an outside of the measuring channel side/bottom walls 9, 10, 11 and an inside of the casing wall 27. This intermediate region 28 is substantially closed by a constriction which runs around the entire measuring channel 7, thus ensuring that virtually no portion of the medium 3 to be detected flows past the measuring path 8 inside the measuring channel 7. The constriction 29, which is formed by a circumferential web-like protrusion on the casing wall 27 in the described embodiment, is so narrow that only a passive flow 30 of the medium 3 flows through the narrow intermediate region 28 that is irrelevant for measurement. In the region of the constriction 29, the casing wall 27 on the one hand and the measuring channel side/bottom walls 9, 10, 11 on the other are in very close proximity to each other, leaving a remaining opening 31 between them. As a result, the intermediate region 28 is on the one hand preferably closed to such an extent that a portion of the medium 3, which flows past the measuring path 8 in the form of a passive flow 30 is irrelevant for detecting the flow rate. On the other hand, the size of the remaining opening is in particular sufficient to ensure a slight passive flow 30 which prevents a dead zone from forming in front of the constriction 29 where medium flow comes to a stop, thus allowing bacteria to develop. In particular, no additional elaborate sealing means are required for producing the construction 29. The constriction 29 formed by the web-like protrusion of the casing wall 27 is perfectly sufficient. In addition or as an alternative, a web-like protrusion forming the constriction 29 may also be formed on the outside of the measuring channel side/bottom walls 9, 10, 11.

The constriction 29 ensures that an excessive passive flow 30 of the medium 3 is guided past the actual measuring path 8 so that there are virtually no measuring errors, with the result that the measuring accuracy of the flow meter 23 is further improved. The order of magnitude of the passive flow 30 occurring in the pipe system is irrelevant for measurement.

What is claimed is:

1. A flow meter for one of a liquid and a gaseous medium (3), the flow meter comprising a casing (2; 24) and a measuring insert (5; 25) which is insertable into said casing (2; 24), wherein the measuring insert (5; 25) as a structural unit includes at least
a) one first sound transducer (13) for emitting a first sound signal (15) into a measuring path (8) through which the medium (3) flows during operation and a second sound transducer (14) for receiving the first sound signal (15) after passing through the measuring path (8); and
b) the measuring path (8) through which the medium (3) flows during operation when the measuring insert (5; 25) is inserted, wherein
c) the measuring path (8) has an actual measuring channel (7) comprising a measuring channel inlet opening (7a) for the medium (3), a measuring channel outlet opening (7b) for the medium (3), and at least one measuring channel wall (9, 10, 11), wherein the measuring channel wall (9, 10, 11) at least partly surrounds the measuring path (8) in the direction of flow (4), and the casing (2; 24) has a casing wall (27), and a constriction (29) is provided in an intermediate region (28) between the measuring channel wall (9, 10, 11) and the casing wall (27) when the measuring insert (5; 25) is inserted, wherein
d) a remaining opening (31) is provided between the measuring channel wall (9, 10, 11) and the casing wall (27) in the region of the constriction (29).

2. A flow meter according to claim 1, wherein the constriction (29) is formed by a protrusion at least on one of the measuring channel wall (9, 10, 11) and the casing wall (27).

3. A flow meter according to claim 1, wherein the constriction (29) runs around the entire measuring channel wall (9, 10, 11).

4. A flow meter according to claim 1, wherein the measuring insert includes at least one end plate (12) which seals a casing opening (6) of the casing (2) into which the measuring insert (5) is insertable in such a way as to prevent an escape of the medium (3) and which is provided with at least one of the two sound transducers (13, 14), and at least one outer transducer cover (17) which covers at least one of the two sound transducers (13, 14) on an outside of the end plate (12) remote from the medium (3).

5. A flow meter according to claim 4, wherein the transducer cover (17) is rigidly secured to the end plate (12).

6. A flow meter according to claim 4, wherein the transducer cover (17) is removable only by means of tools.

7. A flow meter according to claim 4, wherein a seal (18) is arranged between the transducer cover (17) and the end plate (12).

8. A flow meter according to claim 4, wherein an electric connection wire (20, 21) is guided through the transducer cover (17) to at least one of the two sound transducers (13, 14) in a sealed manner.

9. A flow meter according to claim 4, wherein a common transducer cover (17) is provided for the first sound transducer (13) and for the second sound transducer (14).

10. A flow meter according to claim 4, wherein a separate transducer cover is in each case provided for the first sound transducer (13) and for the second sound transducer (14).

11. A flow meter according to claim 4, wherein the measuring insert (5; 25) is insertable into the casing (2; 24) in such as way as to be replaceable.

12. A flow meter according to claim 4, wherein the casing is configured one of as a separate component (24) to be installed into a pipe through which the medium (3) flows and as an integral part of a pipe through which the medium (3) flows.

13. A flow meter according to claim 1, wherein the measuring path (8) has an actual measuring channel (7) comprising a measuring channel wall (9, 10, 11) and that at least the measuring channel wall (9, 10, 11) is one of made from and includes a metal.
